(19) United States
(12) Patent Application Publication
(10) Pub. No.: US 2024/0160181 A1
(43) Pub. Date: May 16, 2024

(54) MOTION-PATH GENERATION DEVICE, NUMERICAL CONTROL DEVICE, NUMERICAL CONTROL SYSTEM, AND NON-TRANSITORY COMPUTER-READABLE MEDIUM STORING COMPUTER PROGRAM

(71) Applicant: FANUC CORPORATION, Yamanashi (JP)

(72) Inventors: Takumi MUROFUSHI, Yamanashi (JP); Kazutaka IMANISHI, Yamanashi (JP)

(73) Assignee: FANUC CORPORATION, Yamanashi (JP)

(21) Appl. No.: 18/548,834

(22) PCT Filed: Mar. 4, 2022
(86) PCT No.: PCT/JP2022/009335

§ 371 Date: Sep. 1, 2023

(30) Foreign Application Priority Data
Mar. 10, 2021 (JP) 2021-038343

(51) Int. Cl. G05B 19/4061; B25J 9/16

(52) U.S. Cl. CPC G05B 19/4061; B25J 9/1666; B25J 9/1671

(57) ABSTRACT

On the basis of a numerical control program for controlling the motion of a machine tool 2, a motion-path generation device 55 generates a motion path concerning control axes of a robot 3 provided in proximity to the machine tool 2. The motion-path generation device 55 comprises: a model update unit 57 that acquires start coordinate values on the control axes and current tool coordinate values of the machine tool 2 and updates a robot system model on the basis of these coordinate values, the robot system model being configured by disposing three-dimensional models of the robot 3, the machine tool 2, and objects in the vicinity of the machine tool 2 in a virtual space; an interference-avoiding-path generation unit 56 that generates a target motion path starting from the start coordinate values and arriving at end coordinate values on the control axes, the end coordinate values being specified on the basis of the numerical control program, while avoiding interference in the robot system model; and a data transmission/reception unit 59 that transmits an instruction including the target motion path to a robot control device 6.

### TECHNICAL FIELD

The present disclosure relates to a motion-path generation device, a numerical control device, a numerical control system, and a computer program.

### BACKGROUND ART

To facilitate automation in workplaces for machining, such a numerical control system has been demanded in recent years that controls in a linked manner motion of a machine tool that machines a workpiece and motion of a robot provided in proximity to the machine tool (for example, see Patent Document 1).

In general, a numerical control program that controls a machine tool and a robot program that controls a robot differ from each other in programming language. To allow motion of a machine tool and motion of a robot to be linked to each other, an operator is therefore required to master both numerical control programs and robot programs.

Patent Document 1 describes a numerical control device that uses a numerical control program to control both a machine tool and a robot. More specifically, in the numerical control system described in Patent Document 1, a robot instruction signal is generated in accordance with a numerical control program in the numerical control device, a robot program is generated based on the robot instruction signal described above in the robot control device, and robot control signals that control motion of the robot in accordance with the robot program are generated. With the numerical control system described in Patent Document 1, a user who is at least familiar with numerical control programs is able to control a robot without mastering robot programs.
Patent Document 1: Japanese Patent No. 6647472
Patent Document 2: Japanese Patent No. 5860081

### DISCLOSURE OF THE INVENTION

### Problems to be Solved by the Invention

By the way, when controlling in a linked manner motion of a machine tool and motion of a robot, it is necessary to create a numerical control program and a robot program to allow the robot to avoid interference with the machine tool and peripheral objects that are present in proximity to the machine tool such as a workpiece stocker and a pallet.

Then, it is conceivable that such a robot simulation device that is described in Patent Document 2 is incorporated into such a numerical control system as described above. With the robot simulation device described in Patent Document 2, disposing three-dimensional models of a robot and peripheral objects that are disposed in proximity to the robot in an identical virtual space to perform a simulation makes it possible to generate such a motion path that allows the robot to avoid interference with the peripheral objects.

However, the simulation device described in Patent Document 2 requires teaching positions to be set beforehand for the robot, requiring a certain period of time for generating such a motion path. Furthermore, since the simulation device described in Patent Document 2 does not take into account controlling in a linked manner motion of a machine tool and motion of a robot, it is necessary, when performing a simulation, to fix beforehand positions of various axes of the machine tool (i.e., positions of a cutter holder and a table for the machine tool, for example). That is, while the machine tool is in operation, the positions of the various axes change in accordance with a numerical control program, possibly leading to interference between the robot and the various axes of the machine tool.

The present disclosure provides a motion-path generation device, a numerical control device, a numerical control system, and a computer program, which makes it possible to generate a motion path that allows a robot to avoid interference with a machine tool that is in operation.

### Means for Solving the Problems

An aspect of the present disclosure provides a motion-path generation device that generates, based on a numerical control program for controlling motion of a machine tool, a motion path concerning control axes of a robot provided in proximity to the machine tool. The motion-path generation device includes: a model update unit that acquires start coordinate values of the control axes and machine coordinate values of the machine tool based on the numerical control program and updates a robot system model based on the start coordinate values and the machine coordinate values, the robot system model being configured by disposing three-dimensional models of the robot, the machine tool, and peripheral objects that are present in proximity to the machine tool in a virtual space; an interference-avoiding-path generation unit that generates a target motion path starting from the start coordinate values and arriving at end coordinate values of the control axes, the end coordinate values being specified based on the numerical control program, while avoiding interference in the robot system model; and a communication unit that transmits an instruction including the target motion path to a robot control device that controls motion of the robot.

Another aspect of the present disclosure provides a numerical control system including: a motion-path generation device that generates, based on a numerical control program for controlling motion of a machine tool, a motion path concerning control axes of a robot provided in proximity to the machine tool; and a robot control device that is communicably coupled to the motion-path generation device and controls motion of the robot based on an instruction transmitted from the motion-path generation device, in which the motion-path generation device includes: a model update unit that acquires start coordinate values of the control axes and machine coordinate values of the machine tool based on the numerical control program and updates a robot system model based on the start coordinate values and the machine coordinate values, the robot system model being configured by disposing three-dimensional models of the robot, the machine tool, and peripheral objects that are present in proximity to the machine tool in a virtual space; an interference-avoiding-path generation unit that generates a target motion path starting from the start coordinate values and arriving at end coordinate values of the control axes, the end coordinate values being specified based on the numerical control program, while avoiding interference in the robot system model; and a communication unit that transmits an instruction including the target motion path to the robot control device, and the robot control device generates a robot program based on the target motion path.

### Effects of the Invention

According to the aspect of the present disclosure, the motion-path generation device acquires start coordinate values and machine coordinate values based on a numerical control program for controlling motion of a machine tool to update a robot system model based on the start coordinate values and the machine coordinate values, making it possible to control in a linked manner motion of a machine tool and motion of a robot based on the numerical control program and to reflect, to the robot system model, a state of the robot and the machine tool, which changes successively. Furthermore, according to the other aspect of the present disclosure, generating a target motion path for a robot based on such a robot system model makes it possible to generate such a target motion path that allows the robot to avoid interference with the machine tool in accordance with a state of the robot and the machine tool, which changes successively.

### BRIEF DESCRIPTION OF THE DRAWINGS

FIG. 1 is a schematic diagram of a numerical control system according to an embodiment of the present disclosure;

FIG. 2 is a functional block diagram of a numerical control device and a robot control device;

FIG. 3 is a first example of a numerical control program;

FIG. 4 is a sequence diagram illustrating how signals and information flow between the numerical control device and the robot control device when the numerical control device is operated based on the numerical control program illustrated in FIG. 3;

FIG. 5 is a second example of a numerical control program;

FIG. 6 is a diagram illustrating an example of a plurality of macro variable sets stored in a macro-variable storage unit;

FIG. 7 is a third example of a numerical control program;

FIG. 8 is a sequence diagram illustrating how signals and information flow between the numerical control device and the robot control device when the numerical control device is operated based on the numerical control program illustrated in FIG. 7;

FIG. 9 is a diagram illustrating an example of a plurality of identifier sets stored in an identifier storage unit; and

FIG. 10 is a fourth example of a numerical control program.

### PREFERRED MODE FOR CARRYING OUT THE INVENTION

A numerical control system 1 according to an embodiment of the present disclosure will now be described herein with reference to the accompanying drawings.

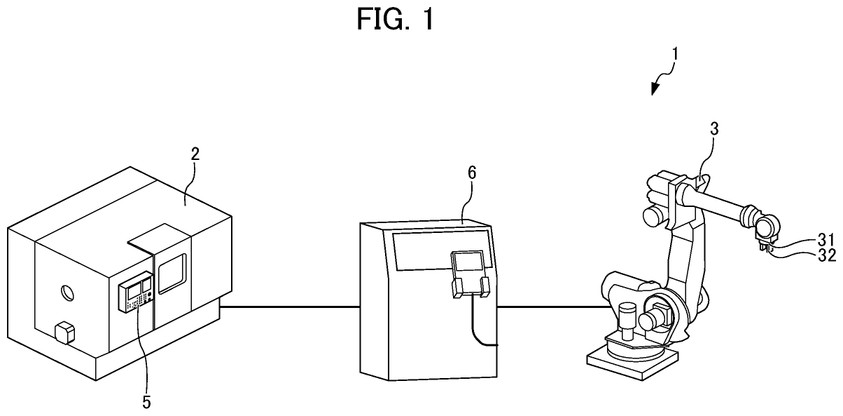

FIG. 1 is a schematic diagram of the numerical control system 1 according to the present embodiment.

The numerical control system 1 includes a machine tool 2 that machines a non-illustrated workpiece, a numerical control device (computer numerical controller or CNC) 5 that controls motion of the machine tool 2, a robot 3 that is provided in proximity to the machine tool 2, and a robot control device 6 that controls motion of the robot 3. The numerical control system 1 uses the numerical control device 5 and the robot control device 6 that are communicably coupled to each other to control in a linked manner motion of the machine tool 2 and motion of the robot 3.

The machine tool 2 machines a non-illustrated workpiece in accordance with machine tool control signals transmitted from the numerical control device 5. Note herein the machine tool 2 is, but not limited to, a lathe, a drilling machine, a milling machine, a grinding machine, a laser processing machine, or an injection molding machine, for example.

The robot 3 operates under the control by the robot control device 6 to perform a predetermined task on a workpiece to be machined by the machine tool 2, for example. The robot 3 is an articulated robot, for example, and has an arm tip portion 31 attached with a tool 32 for holding, for machining, or for inspecting a workpiece. An example to be described below corresponds to, but not limited to, a case when the robot 3 is a six-axis articulated robot. Furthermore, although the example to be described below corresponds to the case when the robot 3 is the six-axis articulated robot, the number of axes is not limited to six.

The numerical control device 5 and the robot control device 6 respectively are computers that each include hardware such as an arithmetic processing means such as a central processing unit (CPU), an auxiliary storage means such as a hard disk drive (HDD) or a solid state drive (SSD) that stores various computer programs, a main storage means such as a random access memory (RAM) that stores data that the arithmetic processing means temporarily requires to execute the computer programs, a maneuver means such as a keyboard with which an operator performs various maneuvers, and a display means that displays various information to the operator. The robot control device 6 and the numerical control device 5 are able to mutually transmit and receive various signals via an Ethernet (registered trademark), for example.

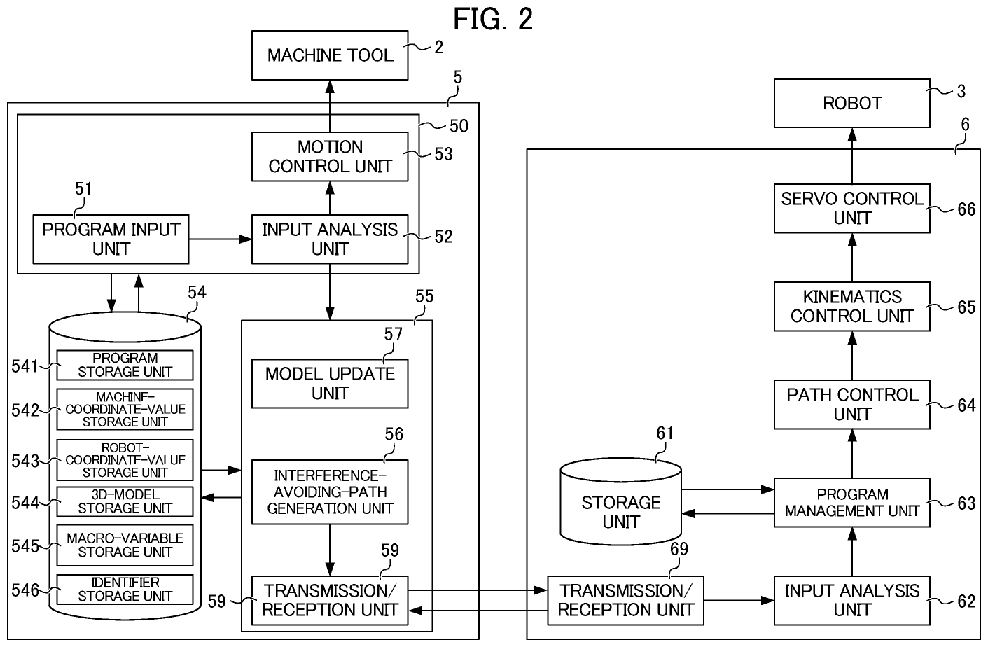

FIG. 2 is a functional block diagram of the numerical control device 5 and the robot control device 6.

A detailed configuration of the numerical control device 5 will first be described. In the numerical control device 5, as illustrated in FIG. 2, the hardware configurations described above achieve various functions such as a machine tool control module 50 that controls motion of the machine tool 2, a motion-path generation device 55 that generates a motion path concerning control axes of a robot, and a storage unit 54.

The storage unit 54 includes a program storage unit 541, a machine-coordinate-value storage unit 542, a robot-coordinate-value storage unit 543, a 3D-model storage unit 544, a macro-variable storage unit 545, and an identifier storage unit 546.

The program storage unit 541 stores a plurality of numerical control programs created based on maneuvers by the operator, for example. More specifically, the program storage unit 541 stores numerical control programs that each include a plurality of instruction blocks for the machine tool 2 for controlling motion of the machine tool 2 and a plurality of instruction blocks for the robot 3 for controlling motion of the robot 3, for example. The numerical control programs stored in the program storage unit 541 are written in known programming languages for controlling motion of the machine tool 2 such as G code and M code.

The machine-coordinate-value storage unit 542 stores machine coordinate values that indicate positions of various axes of the machine tool 2 that operates under the numerical control programs described above (i.e., positions of a cutter holder and a table for the machine tool 2, for example). Note that the machine coordinate values are defined under a machine tool coordinate system in which a reference point specified at a desired position on the machine tool 2 or in proximity to the machine tool 2 serves as its origin. The machine coordinate values that change successively under the numerical control programs are updated successively through non-illustrated processing for storing the latest values in the machine-coordinate-value storage unit 542.

The robot-coordinate-value storage unit 543 stores a position and a posture of a control point (for example, the arm tip portion 31 of the robot 3) of the robot 3 that operates under the control by the robot control device 6, in other words, robot coordinate values that indicate positions of the control axes of the robot 3. Note that the robot coordinate values are defined under a robot coordinate system that differs from the machine tool coordinate system. The robot coordinate values that change successively under the numerical control program are updated successively with the robot coordinate values acquired from the robot control device 6 through non-illustrated processing for storing the latest values in the robot-coordinate-value storage unit 543.

The robot coordinate system is a coordinate system in which a reference point specified at a desired position on the robot 3 or in proximity to the robot 3 serves as its origin. Note that, although a case where the robot coordinate system differs from the machine tool coordinate system will be described below, the present disclosure is not limited to this case. The robot coordinate system and the machine tool coordinate system may coincide with each other. In other words, the origin and the directions of the coordinate axes of the robot coordinate system and the origin and the directions of the coordinate axes of the machine tool coordinate system may coincide with each other.

Furthermore, in the robot coordinate system, its control axes are switchable among two or more different coordinate formats. More specifically, in a numerical control program, the position and the posture of the control point of the robot 3 are specifiable with cartesian coordinate format or a joint coordinate formats.

In the joint coordinate formats, the position and the posture of the control point of the robot 3 are specified with coordinate values of a total of six real numbers that include rotation angle values (J1, J2, J3, J4, J5, and J6) of six joints of the robot 3 as components.

In the cartesian coordinate format, the position and the posture of the control point of the robot 3 are specified with coordinate values of a total of six real numbers that include three coordinate values (X, Y, and Z) respectively along three cartesian coordinate axes and three rotation angle values (A, B, and C) respectively around the cartesian coordinate axes as components.

Note herein that, since the rotation angles of the joints of the robot 3 are directly specified under the joint coordinate formats, the axis arrangement of arms and a wrist of the robot 3 and rotation numbers of the joints that are rotatable each at an angle of 360 degrees or more (hereinafter they are collectively referred to as “configuration of the robot 3”) are also uniquely defined. On the other hand, under the cartesian coordinate format, it is impossible to uniquely define the configuration of the robot 3 since the position and the posture of the control point of the robot 3 are specified by the six coordinate values (X, Y, Z, A, B, and C). Then, in a numerical control program for a robot, it is possible to specify the configuration of the robot 3 with a configuration value P that is an integer value having a predetermined number of digits. Therefore, the position and the posture of the control point of the robot 3 and the configuration of the robot 3 are represented by six coordinate values (J1, J2, J3, J4, J5, and J6) under the joint coordinate formats and by six coordinate values and one configuration value (X, Y, Z, A, B, C, and P) under the cartesian coordinate format. Note that the configuration value P will also be hereinafter referred to as a coordinate value for purpose of convenience.

The 3D-model storage unit 544 stores data pertaining to a robot system model being configured by disposing three-dimensional models that mimic respective three-dimensional shapes of the machine tool 2, the robot 3, and peripheral objects that are present in proximity to the machine tool 2 in a virtual space. Note herein that such peripheral objects include objects that are present within the motion range of the robot 3, such as a workpiece that is a target to be machined by the machine tool 2, a workpiece stocker in which a plurality of such workpieces are stored, a pallet, and a safety fence. The motion-path generation device 55 described later uses the robot system model stored in the 3D-model storage unit 544 to perform a simulation to generate motion path of the control axes of the robot 3, which allows the robot to avoid interference in the robot system model.

The macro-variable storage unit 545 stores a plurality of macro variable sets in a state where the macro variables are respectively associated with robot coordinate values specified by the operator as desired.

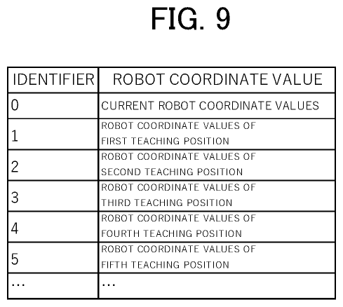

The identifier storage unit 546 stores a plurality of identifier sets in a state where the identifiers are respectively associated with robot coordinate values specified as teaching positions through teaching maneuvers by the operator (see FIG. 9 described later). In the identifier storage unit 546, the robot coordinate values respectively associated with the identifiers as the teaching positions may be acquired from actual coordinate values of the robot 3 or may be acquired from coordinate values of a virtual robot in a virtual space that is achieved in a non-illustrated computer or the 3D-model storage unit 544 coupled to the numerical control device 5.

The machine tool control module 50 includes and uses a program input unit 51, an input analysis unit 52, and a motion control unit 53 to control motion of the machine tool 2 based on a numerical control program.

The program input unit 51 reads a numerical control program from the program storage unit 541 and inputs successively the read numerical control program into the input analysis unit 52.

The input analysis unit 52 performs an analysis for an instruction type per an instruction block based on the numerical control program inputted from the program input unit 51 and transmits a result of the analysis to the motion control unit 53 and the motion-path generation device 55. More specifically, the input analysis unit 52 transmits an instruction, when an instruction type of an instruction block is for the machine tool 2, to the motion control unit 53 and transmits an instruction, when an instruction type of an instruction block is for the robot 3, to the motion-path generation device 55.

The motion control unit 53 generates machine tool control signals for controlling motion of the machine tool 2 in accordance with a result of an analysis, which is transmitted from the input analysis unit 52, and inputs the generated machine tool control signals to actuators that drive the various axes of the machine tool 2. The machine tool 2 operates in accordance with the machine tool control signals inputted from the motion control unit 53 to machine a non-illustrated workpiece. Furthermore, after motion of the machine tool 2 has been controlled in accordance with the numerical control program as described above, the motion control unit 53 updates the machine coordinate values stored in the machine-coordinate-value storage unit 542 with the latest machine coordinate values.

The motion-path generation device 55 generates a motion path concerning the control axes of the robot 3 based on a numerical control program for controlling motion of the machine tool 2, as described above. More specifically, the motion-path generation device 55 includes an interference-avoiding-path generation unit 56, a model update unit 57, and a transmission/reception unit 59.

Note herein that, with a numerical control program, it is possible to cause the motion-path generation device 55 to generate a target motion path for the control axes of the robot 3 by using G codes “G17.4”, “G17.5”, “G17.6”, and “G17.7” and to start a robot program generated in the robot control device 6 based on the target motion path.

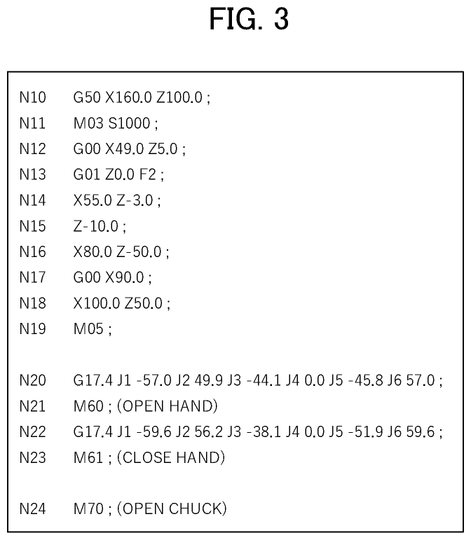

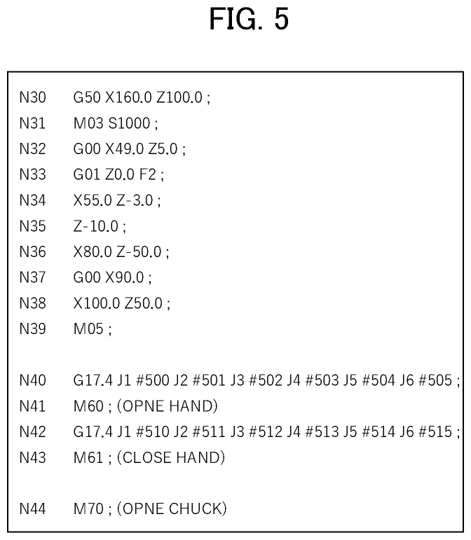

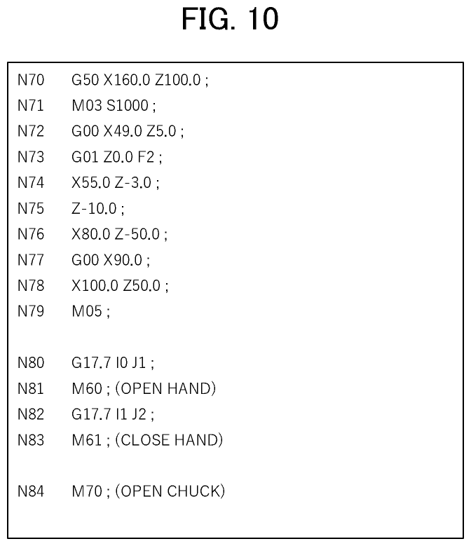

More specifically, G codes “G17.4” and “G17.7” serve as commands for instructing the motion-path generation device 55 and the robot control device 6 to generate a target motion path for the control axes of the robot 3, transmit the generated target motion path to the robot control device 6, and execute the generated robot program in the robot control device 6 based on the target motion path. G codes “G17.4” and “G17.7” will also be hereinafter referred to as motion path generation execution instructions. Note that, under G code “G17.4”, a target motion path is directly specified in a program (see FIG. 3 described later) or is specified by utilizing a macro variable stored in the macro-variable storage unit 545 (see FIG. 5 described later). On the other hand, under G code “G17.7”, a target motion path is specified by utilizing an identifier stored in the identifier storage unit 546 (see FIG. 10 described later).

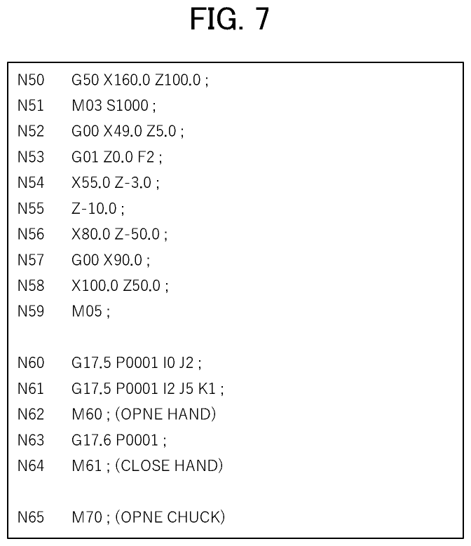

Furthermore, G code “G17.5” serves as a command for instructing the motion-path generation device 55 to generate a target motion path for the control axes of the robot 3 and transmit the generated target motion path to the robot control device 6 (see FIG. 7 described later). G code “G17.5” will also be hereinafter referred to as a motion path generation instruction.

G code “G17.6” serves as a command for instructing the robot control device 6 to execute the generated robot program based on the target motion path described above in the robot control device 6 (see FIG. 7 described later). G code “G17.6” will also be hereinafter referred to as a motion path execution instruction.

The model update unit 57 updates the robot system model stored in the 3D-model storage unit 544 based on a result of an analysis on the numerical control program in the input analysis unit 52. More specifically, the model update unit 57 acquires start coordinate values for the robot 3 and current machine coordinate values of the machine tool 2 when an instruction type based on a numerical control program is a motion path generation instruction or a motion path generation execution instruction and updates the robot system model stored in the 3D-model storage unit 544 based on the start coordinate values and the current machine coordinate values. More specifically, the model update unit 57 updates the robot system model stored in the 3D-model storage unit 544 to allow positions of the control axes of the robot 3 in the robot system model and those indicated by the start coordinate values to coincide with each other and positions of the various axes of the machine tool 2 in the robot system model and those indicated by the current machine coordinate values to coincide with each other.

Note that the model update unit 57 acquires, as current machine coordinate values, the machine coordinate values that are stored in the machine-coordinate-value storage unit 542 and that are to be updated successively based on a numerical control program as described above. Furthermore, the model update unit 57 acquires, as start coordinate values for the robot 3, the robot coordinate values that are stored in the robot-coordinate-value storage unit 543 and that are to be updated successively based on a numerical control program as described above or robot coordinate values specified in the numerical control program.

The interference-avoiding-path generation unit 56 generates a target motion path for the control axes of the robot 3 based on a result of an analysis for the numerical control program in the input analysis unit 52. More specifically, when an instruction type based on a numerical control program is a motion path generation instruction or a motion path generation execution instruction, the interference-avoiding-path generation unit 56 uses the robot system model updated by the model update unit 57 to perform a simulation to generate a target motion path starting from the start coordinate values for the robot 3 and arriving at end coordinate values for the robot 3, the end coordinate values being specified based on the numerical control program, while avoiding interference between the robot 3 and the machine tool 2 and peripheral objects in the robot system model, and writes the generated target motion path into the transmission/reception unit 59.

Note that, similar to the model update unit 57, the interference-avoiding-path generation unit 56 acquires, as start coordinate values for the robot 3, the robot coordinate values stored in the robot-coordinate-value storage unit 543 or robot coordinate values specified in a numerical control program.

Furthermore, when identifiers are specified in a numerical control program, the interference-avoiding-path generation unit 56 acquires robot coordinate values that are associated with the specified identifiers from the identifier storage unit 546 and generates a target motion path by using the acquired robot coordinate values as teaching positions. That is, the interference-avoiding-path generation unit 56 generates a target motion path that passes through the teaching positions, while avoiding interference in the robot system model.

The transmission/reception unit 59 transmits and receives various data such as instructions and robot coordinate values to and from a transmission/reception unit 69 of the robot control device 6. More specifically, when the interference-avoiding-path generation unit 56 has written a target motion path, the transmission/reception unit 59 transmits an instruction including the target motion path to the transmission/reception unit 69 of the robot control device 6. Furthermore, when an instruction type based on a numerical control program is a motion path execution instruction or a motion path generation execution instruction, the transmission/reception unit 59 transmits, after transmitting a target motion path to the transmission/reception unit 69 as described above, an execution instruction for a robot program to be generated in the robot control device 6 based on the target motion path to the transmission/reception unit 69, as will be described later.

Next, the configuration of the robot control device 6 will be described in detail. In the robot control device 6, as illustrated in FIG. 2, the hardware configuration described above achieves various functions such as a storage unit 61, an input analysis unit 62, a program management unit 63, a path control unit 64, a kinematics control unit 65, a servo control unit 66, and the transmission/reception unit 69. The robot control device 6 uses the storage unit 61, the input analysis unit 62, the program management unit 63, the path control unit 64, the kinematics control unit 65, the servo control unit 66, and the transmission/reception unit 69 to control motion of the robot 3 based on an instruction transmitted from the motion-path generation device 55 of the numerical control device 5.

The transmission/reception unit 69 inputs an instruction transmitted from the transmission/reception unit 59 of the numerical control device 5 into the input analysis unit 62.

When an instruction inputted from the transmission/reception unit 69 includes a target motion path, the input analysis unit 62 inputs the target motion path into the program management unit 63. Furthermore, when an instruction inputted from the transmission/reception unit 69 is an execution instruction for a robot program, the input analysis unit 62 inputs a start instruction for the robot program into the program management unit 63.

When a target motion path is inputted from the input analysis unit 62, the program management unit 63 generates a robot program allowing the control axes of the robot 3 to move along the target motion path and causes the storage unit 61 to store the generated robot program.

Furthermore, after generating the robot program based on the target motion path received previously, and when a start instruction for the robot program is inputted from the input analysis unit 62, the program management unit 63 invokes and starts the robot program that corresponds to the start instruction from the storage unit 61. The program management unit 63 executes commands described in the started robot program and notifies successively, to the path control unit 64, movement commands for the control axes of the robot 3.

The path control unit 64 calculates time-series data pertaining to the control point of the robot 3 in accordance with the movement commands to be notified from the program management unit 63 and inputs the calculated time-series data into the kinematics control unit 65.

The kinematics control unit 65 calculates target angles of the joints of the robot 3 from the inputted time-series data and inputs the calculated target angles into the servo control unit 66.

The servo control unit 66 performs feedback control for servo motors of the robot 3 to achieve target angles to be inputted from the kinematics control unit 65 to generate robot control signals for the robot 3 and inputs the generated robot control signals into the servo motors of the robot 3.

Next, how various signals and information flow in the numerical control system 1 configured as described above will be described with reference to FIGS. 3 to 10.

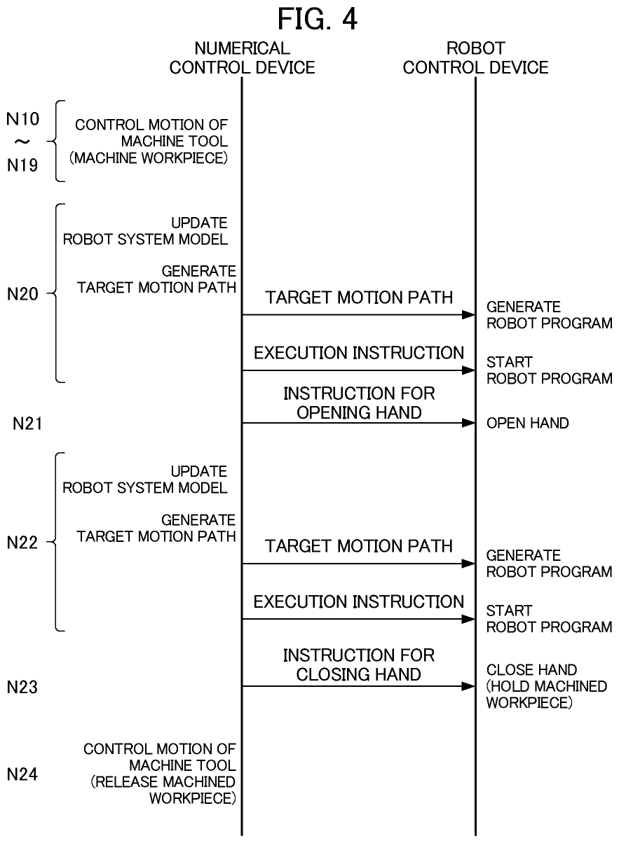

FIG. 3 is a first example of a numerical control program. FIG. 4 is a sequence diagram illustrating how signals and information flow between the numerical control device 5 and the robot control device 6 when the numerical control device 5 is operated based on the numerical control program illustrated in FIG. 3.

The numerical control program illustrated in FIG. 3 is a program that, after a workpiece has been machined by the machine tool 2, causes the robot 3 to hold the machined workpiece and causes the robot 3 to release the machined workpiece from the machine tool 2.

Blocks illustrated by sequence numbers “N10” to “N19” represent instructions for the machine tool 2. More specifically, the block illustrated by sequence number “N10” represents an instruction pertaining to setting of a coordinate system for the machine tool 2, the block illustrated by sequence number “N11” represents an instruction for causing a spindle of the machine tool 2 to rotate at a rotation number of “1000”, the block illustrated by sequence number “N12” represents an instruction for rapid traversing and positioning the spindle of the machine tool 2 to and at a position indicated by machine coordinate values (X=49.0, Z=5.0), and the block illustrated by sequence number “N13” represents an instruction for moving the spindle of the machine tool 2 at a speed of “2” to a position indicated by a machine coordinate value (Z=0.0) in a linear interpolation. The blocks illustrated by sequence numbers “N14” to “N16” respectively represent instructions for moving sequentially the spindle of the machine tool 2 to positions indicated by machine coordinate values (X=55.0, Z=−3.0), (Z=−10.0), and (X=80.0, Z=−50.0) in a linear interpolation. Furthermore, the blocks illustrated by sequence numbers “N17” to “N18” respectively represent instructions for rapid traversing sequentially and positioning the spindle of the machine tool 2 to and at positions indicated by machine coordinate values (X=90.0) and (X=100.0, Z=50.0), and the block illustrated by sequence number “N19” represents an instruction for causing the spindle to stop rotating. The machine tool control module 50 controls motion of the machine tool 2 in accordance with the instructions. Note that, at a point in time when the block illustrated by sequence number “N19” has ended, the machine-coordinate-value storage unit 542 stores the latest machine coordinate values, i.e., the machine coordinate values (X=100.0, Z=50.0) in the example numerical control program illustrated in FIG. 3.

Next, blocks illustrated by sequence numbers “N20” to “N23” represent instructions for the robot 3 that includes the tool 32.

In the block illustrated by sequence number “N20”, G code “G17.4” that represents a motion path generation execution instruction is first inputted into the input analysis unit 52 of the numerical control device 5 and a result of its analysis is inputted into the motion-path generation device 55. Thereby, the model update unit 57 of the motion-path generation device 55 acquires the robot coordinate values stored in the robot-coordinate-value storage unit 543 as start coordinate values, acquires the machine coordinate values stored in the machine-coordinate-value storage unit 542 as current machine coordinate values, and updates the robot system model stored in the 3D-model storage unit 544 based on the start coordinate values and the current coordinate values.

After that, the interference-avoiding-path generation unit 56 of the motion-path generation device 55 acquires the robot coordinate values stored in the robot-coordinate-value storage unit 543 as start coordinate values, and further acquires robot coordinate values specified successively to G code “G17.4”, i.e., robot coordinate values (J1=−57.0, J2=49.9, J3=−44.1, J4=0.0, J5=−45.8, and J6=57.0 in the example illustrated in FIG. 3) as end coordinate values. Furthermore, the interference-avoiding-path generation unit 56 uses the robot system model after being updated by the model update unit 57 to perform a simulation to generate a target motion path starting from the acquired start coordinate values and arriving at the end coordinate values, while avoiding interference in the robot system model.

After that, the transmission/reception unit 59 of the motion-path generation device 55 transmits, to the robot control device 6, an instruction that includes the target motion path generated by the interference-avoiding-path generation unit 56. Thereby, the robot control device 6 generates a robot program based on the received target motion path.

After that, the transmission/reception unit 59 of the motion-path generation device 55 transmits, to the robot control device 6, an execution instruction for the robot program generated in the robot control device 6. Thereby, the robot control device 6 starts the generated robot program and controls motion of the robot 3 in accordance with commands described in the robot program. Thereby, the robot coordinate values of the control axes of the robot 3 shift from the start coordinate values to the end coordinate values along the target motion path.

Next, in the block illustrated by sequence number “N21”, “M60” that represents an instruction for the tool 32 is inputted into a robot instruction generation unit (not shown) of the numerical control device 5. Thereby, the robot instruction generation unit transmits an instruction for opening a hand that is attached to the robot 3 and that serves as the tool 32 via the transmission/reception unit 59 to the robot control device 6. Thereby, the robot control device 6 causes the hand to open while the control axes of the robot 3 are secured in position.

Next, in the block illustrated by sequence number “N22”, G code “G17.4” that represents a motion path generation execution instruction is again inputted into the input analysis unit 52 of the numerical control device 5 and a result of its analysis is inputted into the motion-path generation device 55. Thereby, the motion-path generation device 55 updates the robot system model with a procedure that is identical to that for the block illustrated by sequence number “N20”, generates a target motion path while specifying robot coordinate values (J1=−59.6, J2=56.2, J3=−38.1, J4=0.0, J5=−51.9, and J6=59.6) that are specified to be in proximity to the workpiece for the machine tool 2 as end coordinate values, and transmits an instruction that includes the target motion path to the robot control device 6. After that, the motion-path generation device 55 transmits, to the robot control device 6, an execution instruction for the robot program generated in the robot control device 6 based on the target motion path. Thereby, the robot coordinate values of the control axes of the robot 3 shift along the target motion path.

Next, in the block illustrated by sequence number “N23”, “M61” that represents an instruction for the tool 32 is inputted into the robot instruction generation unit of the numerical control device 5. Thereby, the robot instruction generation unit transmits an instruction for closing the hand attached to the robot 3 via the transmission/reception unit 59 to the robot control device 6. Thereby, the robot control device 6 causes the hand to close while the control axes of the robot 3 are secured in position. Furthermore, the workpiece for the machine tool 2 is thereby held by the hand attached to the robot 3.

Next, the block illustrated by sequence number “N24” represents an instruction for the machine tool 2. More specifically, the block illustrated by sequence number “N24” represent an instruction for opening the chuck that is holding the workpiece in the machine tool 2. Thereby, the machine tool 2 releases the workpiece. Therefore, after that, the robot 3 is able to convey the machined workpiece to a predetermined position.

FIG. 5 is a second example of a numerical control program. In the second example illustrated in FIG. 5, blocks illustrated by sequence numbers “N30” to “N39”, “N41”, “N43”, and “N44” are respectively identical to the blocks illustrated by sequence numbers “N10” to “N19”, “N21”, “N23”, and “N24” illustrated in FIG. 3, and their detailed descriptions are thus omitted. Furthermore, in the second example illustrated in FIG. 5, blocks illustrated by sequence numbers “N40” and “N42” only represent differences from those in the first example illustrated in FIG. 3. Furthermore, operation of the machine tool 2 and the robot 3, which is achieved by the numerical control program illustrated in FIG. 5, is substantially identical to that achieved by the numerical control program illustrated in FIG. 3.

In the first example illustrated in FIG. 3, described is a case when directly describing, in a numerical control program, end coordinate values for the robot 3 when generating a target motion path. On the other hand, in FIG. 5, illustrated is a case when specifying end coordinate values for the robot 3 by utilizing macro variables “500” to “505” and “510” to “515”.

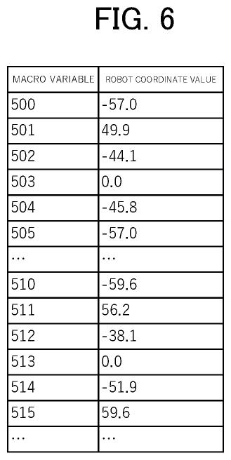

FIG. 6 is a diagram illustrating an example of a plurality of macro variable sets stored in the macro-variable storage unit 545. In the example illustrated in FIG. 6, macro variable “500” is associated with value “−57.0”, macro variable “501” is associated with value “49.9”, macro variable “502” is associated with value “−44.1”, macro variable “503” is associated with value “0.0”, macro variable “504” is associated with value “−45.8”, and macro variable “505” is associated with value “−57.0”. Furthermore, macro variable “510” is associated with value “−59.6”, macro variable “511” is associated with value “56.2”, macro variable “512” is associated with value “−38.1”, macro variable “513” is associated with value “0.0”, macro variable “514” is associated with value “−51.9”, and macro variable “515” is associated with value “59.6”. According to the second example illustrated in FIG. 5, by associating macro variables with values, as illustrated in FIG. 6, a target motion path that is similar to that in the first example illustrated in FIG. 3 is generated.

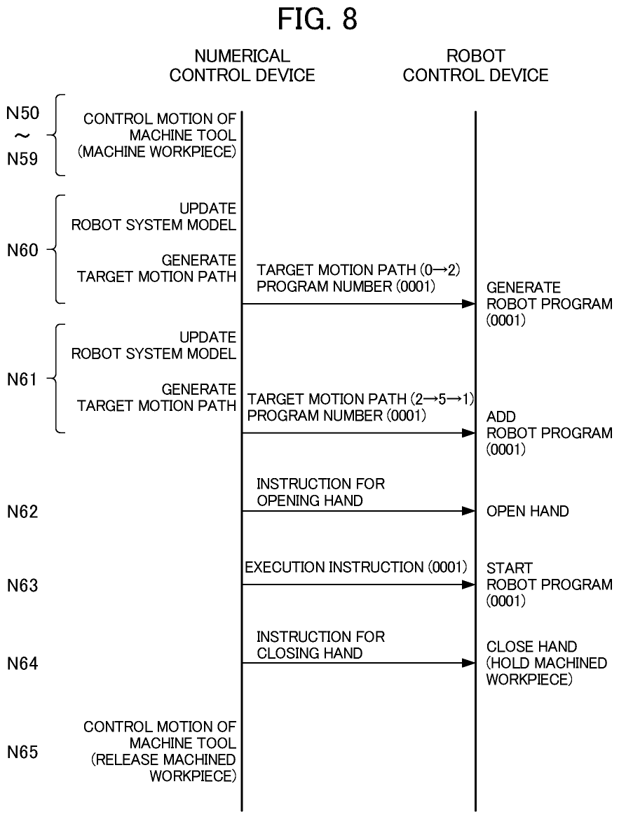

FIG. 7 is a third example of a numerical control program. FIG. 8 is a sequence diagram illustrating how signals and information flow between the numerical control device 5 and the robot control device 6 when the numerical control device 5 is operated based on the numerical control program illustrated in FIG. 7.

FIG. 9 is a diagram illustrating an example of a plurality of identifier sets stored in the identifier storage unit 546. In the example illustrated in FIG. 9, identifier “0” is associated with current robot coordinate values, i.e., the robot coordinate values stored in the robot-coordinate-value storage unit 543, identifier “1” is associated with robot coordinate values of a predetermined first teaching position, identifier “2” is associated with robot coordinate values of a predetermined second teaching position, identifier “3” is associated with robot coordinate values of a predetermined third teaching position, identifier “4” is associated with robot coordinate values of a predetermined fourth teaching position, and identifier “5” is associated with robot coordinate values of a predetermined fifth teaching position.

The numerical control program illustrated in FIG. 7 is, similar to the numerical control program illustrated in FIG. 3, a program that, after a workpiece has been machined by the machine tool 2, causes the robot 3 to hold the machined workpiece and causes the robot 3 to release the machined workpiece from the machine tool 2.

In blocks illustrated by sequence numbers “N50” to “N59”, instructions for the machine tool 2 are first inputted into the machine tool control module 50 of the numerical control device 5. Note that the blocks illustrated by sequence numbers “N50” to “N59” are respectively identical to the blocks illustrated by sequence numbers “N10” to “N19” illustrated in FIG. 3, and their detailed descriptions are thus omitted.

Next, in a block illustrated by sequence number “N60”, G code “G17.5” that represents a motion path generation instruction is inputted into the input analysis unit 52 of the numerical control device 5 and a result of its analysis is inputted into the motion-path generation device 55. Thereby, the model update unit 57 of the motion-path generation device 55 acquires, as start coordinate values, robot coordinate values that are associated with an identifier described successively to letter “I” in the same block (i.e., the current robot coordinate values in the example illustrated in FIG. 9), acquires, as current machine coordinate values, the machine coordinate values stored in the machine-coordinate-value storage unit 542, and updates the robot system model stored in the 3D-model storage unit 544 based on the start coordinate value and the current machine coordinate values.

After that, the interference-avoiding-path generation unit 56 of the motion-path generation device 55 acquires, as start coordinate values, the robot coordinate values that are associated with the identifier described successively to letter “I” in the same block (i.e., the current robot coordinate values in the example illustrated in FIG. 9), and further acquires, as end coordinate values, robot coordinate values that are associated with an identifier described successively to letter “J” in the same block (i.e., the robot coordinate values of the second teaching position in the example illustrated in FIG. 9). Furthermore, the interference-avoiding-path generation unit 56 uses the robot system model after updated by the model update unit 57 to perform a simulation to generate a target motion path starting from the acquired start coordinate values and arriving at the end coordinate values, while avoiding interference in the robot system model.

After that, the transmission/reception unit 59 of the motion-path generation device 55 transmits, to the robot control device 6, an instruction that includes the target motion path generated by the interference-avoiding-path generation unit 56 and the program number described successively to letter “P” in the same block (0001 in the example illustrated in FIG. 7). Thereby, the robot control device 6 generates a robot program with the received program number (0001) based on the received target motion path.

Next, in a block illustrated by sequence number “N61”, G code “G17.5” that represents a motion path generation instruction is inputted into the motion-path generation device 55 of the numerical control device 5. Thereby, the model update unit 57 of the motion-path generation device 55 acquires, as start coordinate values, robot coordinate values that are associated with an identifier described successively to letter “I” in the same block (i.e., the robot coordinate values of the second teaching position in the example illustrated in FIG. 9), acquires, as current machine coordinate values, the machine coordinate values stored in the machine-coordinate-value storage unit 542, and updates the robot system model stored in the 3D-model storage unit 544 based on the start coordinate values and the current machine coordinate values.

After that, the interference-avoiding-path generation unit 56 of the motion-path generation device 55 acquires, as start coordinate values, the robot coordinate values that are associated with the identifier described successively to letter “I” in the same block (i.e., the robot coordinate values of the second teaching position in the example illustrated in FIG. 9), further acquires, as intermediate coordinate values, robot coordinate values that are associated with an identifier described successively to letter “J” in the same block (i.e., the robot coordinate values of the fifth teaching position in the example illustrated in FIG. 9), and further acquire, as end coordinate values, robot coordinate values that are associated with an identifier described successively to letter “K” in the same block (i.e., the robot coordinate values of the first teaching position specified in proximity to the workpiece for the machine tool 2 in the example illustrated in FIG. 9). Furthermore, the interference-avoiding-path generation unit 56 uses the robot system model after updated by the model update unit 57 to perform a simulation to generate a target motion path starting from the acquired start coordinate values, via the intermediate coordinate values, and arriving at the end coordinate values, while avoiding interference in the robot system model.

After that, the transmission/reception unit 59 of the motion-path generation device 55 transmits, to the robot control device 6, an instruction that includes the target motion path generated by the interference-avoiding-path generation unit 56 and the program number described successively to letter “P” in the same block (0001 in the example illustrated in FIG. 7). Thereby, the robot control device 6 generates a robot program with the received program number (0001) based on the received target motion path. Note that, in the example illustrated in FIG. 7, the program number specified in sequence number “N61” and the program number specified in sequence number “N60” are identical to each other, i.e., “0001”. Therefore, in this case, the robot control device 6 adds the robot program generated based on the instruction with sequence number “N61” to the robot program generated based on the instruction with sequence number “N60”.

Next, in a block illustrated by sequence number “N62”, “M60” that represents an instruction for the hand attached to the robot 3 is inputted into the robot instruction generation unit (not shown) of the numerical control device 5. Thereby, the robot control device 6 uses a procedure that is identical to that for sequence number “N21” illustrated in FIG. 3 to cause the hand to open while the control axes of the robot 3 are secured in position.

Next, in a block illustrated by sequence number “N63”, G code “G17.6” that represents a motion path execution instruction is inputted into the input analysis unit 52 of the numerical control device 5 and a result of its analysis is inputted into the motion-path generation device 55. Thereby, the transmission/reception unit 59 of the motion-path generation device 55 transmits, to the robot control device 6, an execution instruction for the robot program with program number “0001”, which is generated in the robot control device 6. Thereby, the robot control device 6 starts the robot program with program number “0001” and controls motion of the robot 3 in accordance with commands described in the robot program. Thereby, the robot coordinate values of the control axes of the robot 3 shift, along the target motion path, from the start coordinate values, via that of the second teaching position and that of the fifth teaching position, to that of the first teaching position specified in proximity to the workpiece for the machine tool 2.

Next, in a block illustrated by sequence number “N64”, “M61” that represents an instruction for the hand attached to the robot 3 is inputted into the robot instruction generation unit of the numerical control device 5. Thereby, the robot control device 6 uses a procedure that is identical to that for sequence number “N23” illustrated in FIG. 3 to cause the hand to close while the control axes of the robot 3 are secured in position. Furthermore, the workpiece for the machine tool 2 is thereby held by the hand attached to the robot 3.

Next, a block illustrated by sequence number “N65” represents an instruction for causing the chuck that holds the workpiece in the machine tool 2 to open, similar to sequence number “N24” illustrated in FIG. 3. Thereby, the machine tool 2 releases the workpiece. Therefore, after that, the robot 3 is able to convey the machined workpiece to a predetermined position

FIG. 10 is a fourth example of a numerical control program. In the fourth example illustrated in FIG. 10, blocks illustrated by sequence numbers “N70” to “N79”, “N81”, “N83”, and “N84” are respectively identical to the blocks illustrated by sequence numbers “N50” to “N59”, “N62”, “N64”, and “N65” illustrated in FIG. 7, and their detailed descriptions are thus omitted. Furthermore, in the fourth example illustrated in FIG. 10, blocks illustrated by sequence numbers “N80” and “N82” only represent differences from those in the third example illustrated in FIG. 7. Furthermore, operation of the machine tool 2 and the robot 3, which is achieved by the numerical control program illustrated in FIG. 10, is substantially identical to that achieved by the numerical control program illustrated in FIG. 7.

In the block illustrated by sequence number “N80”, G code “G17.7” that represents a motion path generation execution instruction is inputted into the input analysis unit 52 of the numerical control device 5 and a result of its analysis is inputted into the motion-path generation device 55. Thereby, the model update unit 57 of the motion-path generation device 55 acquires, as start coordinate values, robot coordinate values that are associated with an identifier described successively to letter “I” in the same block (i.e., the current robot coordinate values in the example illustrated in FIG. 9), acquires, as current machine coordinate values, the machine coordinate values stored in the machine-coordinate-value storage unit 542, and updates the robot system model stored in the 3D-model storage unit 544 based on the start coordinate values and the current machine coordinate values.

After that, the interference-avoiding-path generation unit 56 of the motion-path generation device 55 acquires, as start coordinate values, the robot coordinate values that are associated with the identifier described successively to letter “I” in the same block (i.e., the current robot coordinate values in the example illustrated in FIG. 9), and further acquires, as end coordinate values, robot coordinate values that are associated with an identifier described successively to letter “J” in the same block (i.e., the robot coordinate values of the first teaching position in the example illustrated in FIG. 9). Furthermore, the interference-avoiding-circuit generation unit 56 uses the robot system model after updated by the model update unit 57 to perform a simulation to generate a target motion path starting from the acquired start coordinate values and arriving at the end coordinate values, while avoiding interference in the robot system model.

After that, the transmission/reception unit 59 of the motion-path generation device 55 transmits, to the robot control device 6, an instruction that includes the target motion path generated by the interference-avoiding-path generation unit 56. Thereby, the robot control device 6 generates a robot program based on the received target motion path.

After that, the transmission/reception unit 59 of the motion-path generation device 55 transmits, to the robot control device 6, an execution instruction for the robot program generated in the robot control device 6. Thereby, the robot control device 6 starts the generated robot program and controls motion of the robot 3 in accordance with commands described in the robot program. Thereby, the robot coordinate values of the control axes of the robot 3 shift from the start coordinate values to the first teaching position along the target motion path.

Next, in the block illustrated by sequence number “N82”, G code “G17.7” that represents a motion path generation execution instruction is again inputted into the input analysis unit 52 of the numerical control device 5 and a result of its analysis is inputted into the motion-path generation device 55. Thereby, the motion-path generation device 55 updates the robot system model with a procedure that is identical to that for the block illustrated by sequence number “N80”, generates a target motion path by using, as end coordinate values, robot coordinate values that are associated with an identifier described successively to letter “J” (i.e., the robot coordinate values of the second teaching position in the example illustrated in FIG. 9), and transmits an instruction that includes the target motion path to the robot control device 6. After that, the motion-path generation device 55 transmits, to the robot control device 6, an execution instruction for the robot program generated in the robot control device 6 based on the target motion path. Thereby, the robot coordinate values of the control axes of the robot 3 shift, along the target motion path, from that of the first teaching position to that of the second teaching position that is set in proximity to the workpiece for the machine tool 2.

The present disclosure is not limited to the embodiment described above, but may be changed and modified in a wide variety of ways. For example, the embodiment described above has been described with reference to a case when the motion-path generation device 55 and the 3D-model storage unit 544 are achieved with computer programs installed in the numerical control device 5. However, the present disclosure is not limited to this configuration. The motion-path generation device 55 and the 3D-model storage unit 544 may be achieved with computer programs installed into a server that is communicably coupled to the numerical control device 5 and the robot control device 6 respectively.

### EXPLANATION OF REFERENCE NUMERALS

1 Numerical control system
2 Machine tool
3 Robot
5 Numerical control device
50 Machine tool control module
54 Storage unit
541 Program storage unit
542 Machine-coordinate-value storage unit
543 Robot-coordinate-value storage unit
544 3D-model storage unit
545 Macro-variable storage unit
546 Identifier storage unit
55 Motion-path generation device
56 Interference-avoiding-path generation unit
57 Model update unit
59 Transmission/reception unit (communication unit)
6 Robot control device

1. A motion-path generation device that generates, based on a numerical control program for controlling motion of a machine tool, a motion path concerning control axes of a robot provided in proximity to the machine tool, the motion-path generation device comprising:
a model update unit that acquires start coordinate values of the control axes and machine coordinate values of the machine tool based on the numerical control program and updates a robot system model based on the start coordinate values and the machine coordinate values, the robot system model being configured by disposing three-dimensional models of the robot, the machine tool, and peripheral objects that are present in proximity to the machine tool in a virtual space;
an interference-avoiding-path generation unit that generates a target motion path starting from the start coordinate values and arriving at end coordinate values of the control axes, the end coordinate values being specified based on the numerical control program, while avoiding interference in the robot system model; and
a communication unit that transmits an instruction including the target motion path to a robot control device that controls motion of the robot.

2. The motion-path generation device according to claim 1, further comprising an identifier storage unit that stores a plurality of identifier sets that are associated with coordinate values of the control axes,
wherein the interference-avoiding-path generation unit generates the target motion path that passes through coordinate values that are associated with identifiers specified based on the numerical control program, while avoiding interference in the robot system model.

3. The motion-path generation device according to claim 1, wherein the peripheral objects include at least one of a workpiece, a workpiece stocker, a pallet, or a safety fence.

4. A numerical control device comprising:
a program storage unit that stores the numerical control program; and
the motion-path generation device according to claim 1.

5. A numerical control system comprising:
a motion-path generation device that generates, based on a numerical control program for controlling motion of a machine tool, a motion path concerning control axes of a robot provided in proximity to the machine tool; and
a robot control device that is communicably coupled to the motion-path generation device and controls motion of the robot based on an instruction transmitted from the motion-path generation device,
wherein the motion-path generation device includes:
a model update unit that acquires start coordinate values of the control axes and machine coordinate values of the machine tool based on the numerical control program and updates a robot system model based on the start coordinate values and the machine coordinate values, the robot system model being configured by disposing three-dimensional models of the robot, the machine tool, and peripheral objects that are present in proximity to the machine tool in a virtual space;
an interference-avoiding-path generation unit that generates a target motion path starting from the start coordinate values and arriving at end coordinate values of the control axes, the end coordinate values being specified based on the numerical control program, while avoiding interference in the robot system model; and
a communication unit that transmits an instruction including the target motion path to the robot control device, and
the robot control device generates a robot program based on the target motion path.

6. The numerical control system according to claim 5, wherein the communication unit transmits an execution instruction for the robot program to the robot control device, after transmitting the target motion path to the robot control device, and
the robot control device starts the robot program in response to receiving the execution instruction.

7. A non-transitory computer-readable medium storing a computer program that causes a computer that stores a numerical control program for controlling motion of a machine tool to execute:
a step of acquiring, based on the numerical control program, start coordinate values of control axes of a robot provided in proximity to the machine tool and machine coordinate values of the machine tool;
a step of updating, based on the start coordinate values and the machine coordinate values, a robot system model being configured by disposing three-dimensional models of the robot, the machine tool, and peripheral objects that are present in proximity to the machine tool in a virtual space;
a step of generating a target motion path starting from the start coordinate values and arriving at end coordinate values of the control axes, the end coordinate values being specified based on the numerical control program, while avoiding interference in the robot system model; and
a step of transmitting an instruction including the target motion path to a robot control device that controls motion of the robot.
